(19) United States
(12) Patent Application Publication
(10) Pub. No.: US 2025/0379735 A1
(43) Pub. Date: Dec. 11, 2025

(54) Quantum-Resistant Password-Authenticated Key Exchanges

(71) Applicant: Apple Inc., Cupertino, CA (US)

(72) Inventors: Jelle V. Vos, Delft (NL); Yannick L. Sierra, San Francisco, CA (US); Catherine Yun, San Jose, CA (US); Steven A. Myers, Woodside, CA (US)

(21) Appl. No.: 19/230,303

(22) Filed: Jun. 6, 2025

Related U.S. Application Data
(60) Provisional application No. 63/657,668, filed on Jun. 7, 2024.
(60) Provisional application No. 63/709,786, filed on Oct. 21, 2024.

(51) Int. Cl. H04L 9/30; H04L 9/08; H04L 9/32

(52) U.S. Cl. CPC H04L 9/3066; H04L 9/0863; H04L 9/3226

(57) ABSTRACT

Techniques are disclosed relating to quantum resistant cryptography. In some embodiments, a shared secret is established for secure communication between a first device and a second device using a hybrid password-authenticated key exchange (PAKE). The hybrid PAKE includes deriving an initial secret using an elliptic-curve key exchange (ECKE) using a generator selected based on a password, encrypting, using the initial secret, a public key of a key encapsulation mechanism (KEM) for transmission to the second device, decrypting, using the initial secret, a ciphertext received from the second device encapsulating the shared secret using the public key, and decapsulating the shared secret from the decrypted ciphertext using a private key of the KEM.

The present application claims priority U.S. Prov. Appl. No. 63/709,786, entitled “Quantum-Resistant Password-Authenticated Key Exchanges,” filed Oct. 21, 2024, and to U.S. Prov. Appl. No. 63/657,668, entitled “Quantum-Resistant Password-Authenticated Key Exchanges,” filed Jun. 7, 2024, which is incorporated by reference herein in its entirety.

### BACKGROUND

### Technical Field

This disclosure relates generally to cryptography, and, more specifically, to computing devices that implement quantum-resistant cryptographic algorithms.

### Description of the Related Art

Quantum computers pose a significant threat to existing asymmetric cryptographic algorithms because they can solve certain mathematical problems much more efficiently than classical computers, by leveraging quantum phenomena such as superposition and entanglement for parallel processing. Traditional public-key cryptography has relied on computational difficulty of particular problems. For instance, Rivest-Shamir-Adleman (RSA) encryption relies on the property that multiplying two large prime numbers is easy but factoring them is hard for classical computers. With Shor's Algorithm, however, quantum computers can efficiently factor large integers, rendering RSA and other asymmetric encryption schemes insecure. This looming vulnerability has driven the development of quantum-resistant cryptography, aiming to safeguard information in the post-quantum era.

### BRIEF DESCRIPTION OF THE DRAWINGS

FIG. 1 is a block diagram illustrating an example of two devices securing a communication using a quantum-resistant password-authenticated key exchange (PAKE).

FIG. 2A-F are diagrams illustrating examples of quantum-resistant hybrid PAKEs.

FIGS. 3A-D are diagrams illustrating examples of quantum-resistant augmented PAKEs.

FIGS. 4A-H are diagrams illustrating examples of PAKEs using a repacking algorithm and randomized decompression algorithm to improve security of the PAKE.

FIGS. 5A-6B are flow diagrams illustrating examples of methods performed using techniques described herein.

FIG. 7 is a block diagram illustrating an example computing device implementing functionality described herein.

FIG. 8 is a diagram illustrating example applications for systems and devices implementing functionality described herein.

### DETAILED DESCRIPTION

Symmetric encryption using a shared key can allow for efficient secure communication between two parties and is not affected by Shor's algorithm. Asking a user to remember a symmetric key by heart or to type one in manually, however, is impractical. Password-authenticated key exchanges (PAKEs) provide a way for users to establish a strong shared key from a low-entropy password instead, without requiring additional cryptographic keys to be exchanged or stored. This property makes PAKEs particularly useful in scenarios where key exchange is difficult or impractical, such as when users need to authenticate with a server before negotiating a secure connection. Nevertheless, since current PAKEs depend on conventional asymmetric cryptography, they are vulnerable to Shor's algorithm.

The present disclosure describes various embodiments of quantum-resistant/post-quantum PAKEs used to secure communication between computing devices. As will be described below in some embodiments, a shared secret can be established for securing communication between a first device and a second device by using one of multiple hybrid password-authenticated key exchanges (PAKEs) in which a pre-quantum key exchange, such as an elliptic-curve key exchange, is used to wrap a post-quantum key exchange mechanism (KEM), such as a Module-Lattice based Key-Encapsulation Mechanism (ML-KEM). In some embodiments discussed below, a quantum resistant PAKE can be transformed into an augmented password-authenticated key exchange (APAKE), which can provide greater security, by using a persisted public key generated by a KEM based on a password. Various other techniques will also be discussed to improve the security of quantum-resistant PAKES.

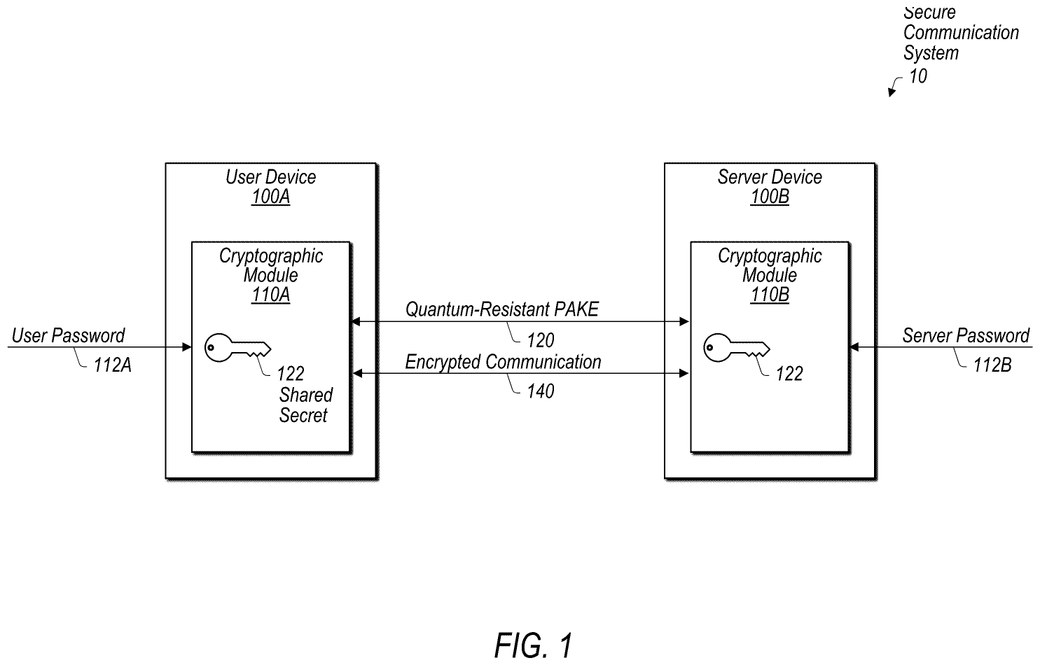

Turning now to FIG. 1, a block diagram of a secure communication system 10 using a quantum-resistant PAKE is depicted. In the illustrated embodiment, system 10 includes a user device 100A and server device 100B, which include cryptographic modules 110A and 110B, respectively. As will be discussed, devices 100 may perform a quantum-resistant PAKE 120 based on passwords 112A and 112B to establish a shared secret 122 used to encrypt communication 140 between devices 100.

Devices 100 may correspond to any suitable computing devices/systems. In some embodiments, one or both of devices 100 are mobile devices such as a mobile phone, tablet computer, handheld computer, music player, laptop or notebook computer, personal data assistant (PDA), consumer device, etc. In some embodiments, one or both of devices 100 are an internet of things (IoT) device, server system, desktop computer, mainframe computer system, workstation, network computer, etc. In some embodiments, one or both of devices 100 are a wearable device such as a watch, athletic sensor, or a head mounted display, which may be a headset, helmet, goggles, glasses, a phone inserted into an enclosure, etc. In some embodiments, one or both of devices 100 are a vehicle such as an aircraft, marine vessels, recreational vehicles (RVs), automobiles, buses, railed vehicles, spacecraft, robotic devices, trucks, trailers, cranes, caterpillars, etc. Although the relationship of devices 100A and 100B is shown as a server client relationship in the illustrated embodiment, devices 100 may be peer devices in other embodiments.

Devices 100 may use a quantum-resistant PAKE 120 for any of various purposes. For example, PAKE 120 may be used for device pairing/bonding such as associating a device 100A to a user account maintained by device 100B, device 100A presenting content on a display of device 100B, device 100A using device 100B as an accessory, etc. PAKE 120 may be used to establish a shared secret 122 for end-to-end encryption of messages between devices 100, which may include text messages, emails, push notifications, etc. User device 100A may perform PAKE 120 for remote access to server device 100B, such as to establish a virtual private network (VPN) tunnel, secure shell (SSH) session, or remote desktop (RDP) connection. Devices 100 may use PAKE 120 for performing a file transfer via the secure communication encrypted using the shared secret such as migrating data from device 100A to device 100B. Devices 100 may use PAKE 120 to provide end-to-end encryption for Voice over Internet Protocol (VOIP) communications to ensure that voice conversations remain private and secure. In some embodiments, server device 100B is a Wi-Fi® access point that user device 100A connects to using PAKE 120. In some embodiments, server device 100B implements a cloud-based service accessible to device 100A, which uses a PAKE 120 to authenticate and establish a secure communication 140 via Transport Layer Security (TLS), Hypertext Transfer Protocol Secure (HTTPS), etc. User data stored on the cloud-based service may also be protected using PAKE 120.

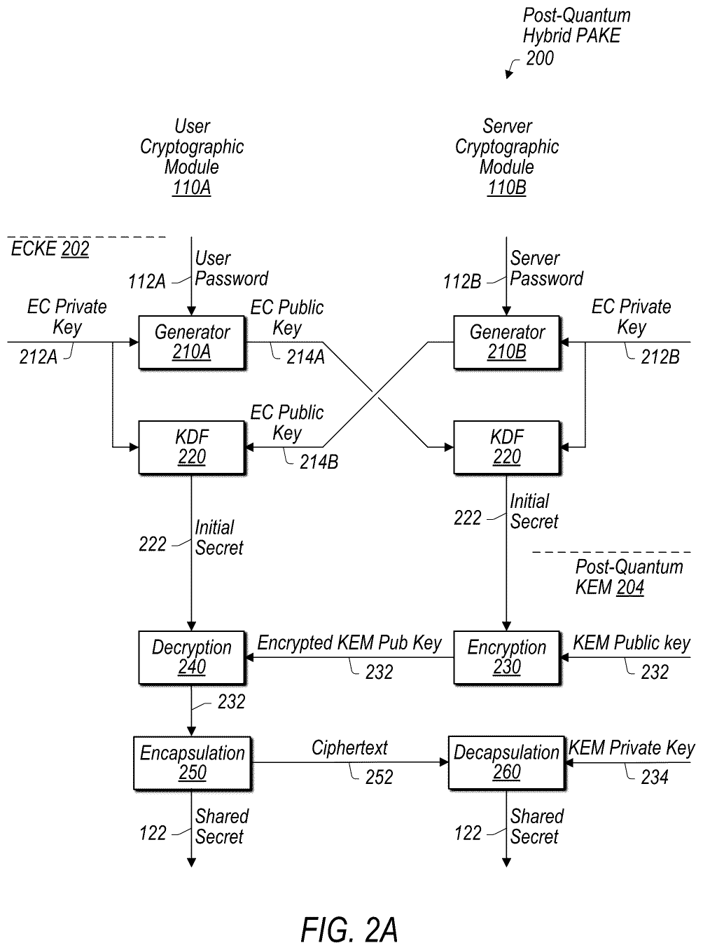

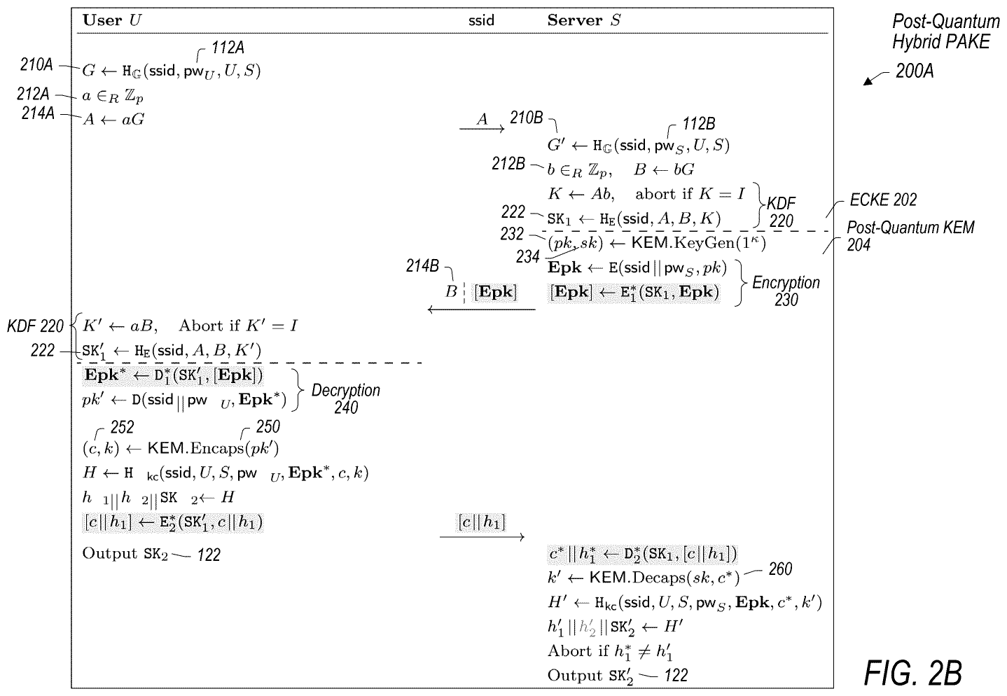

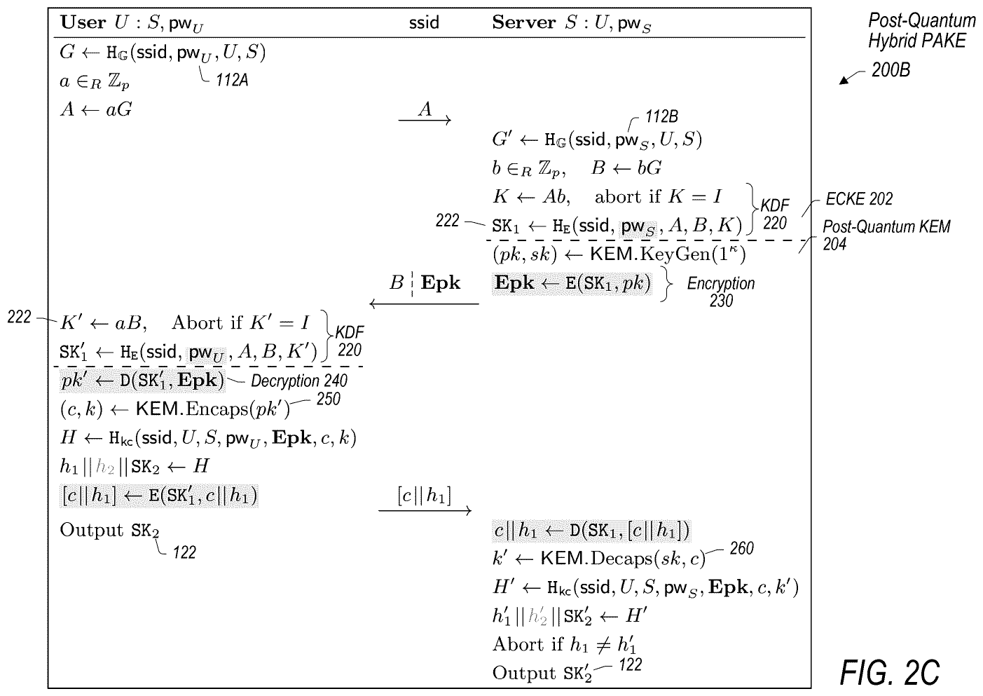

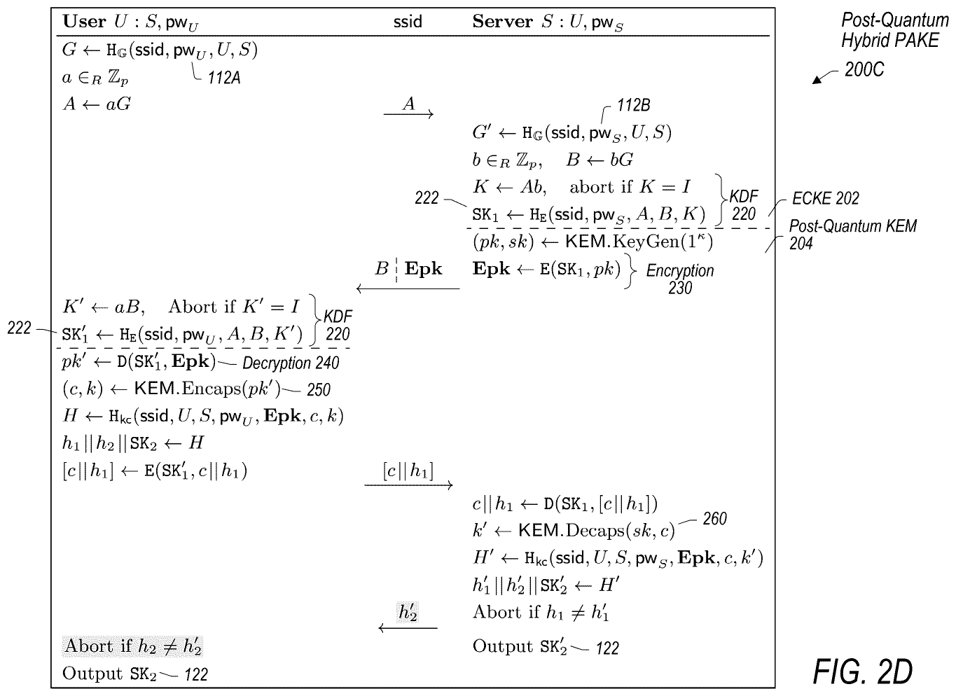

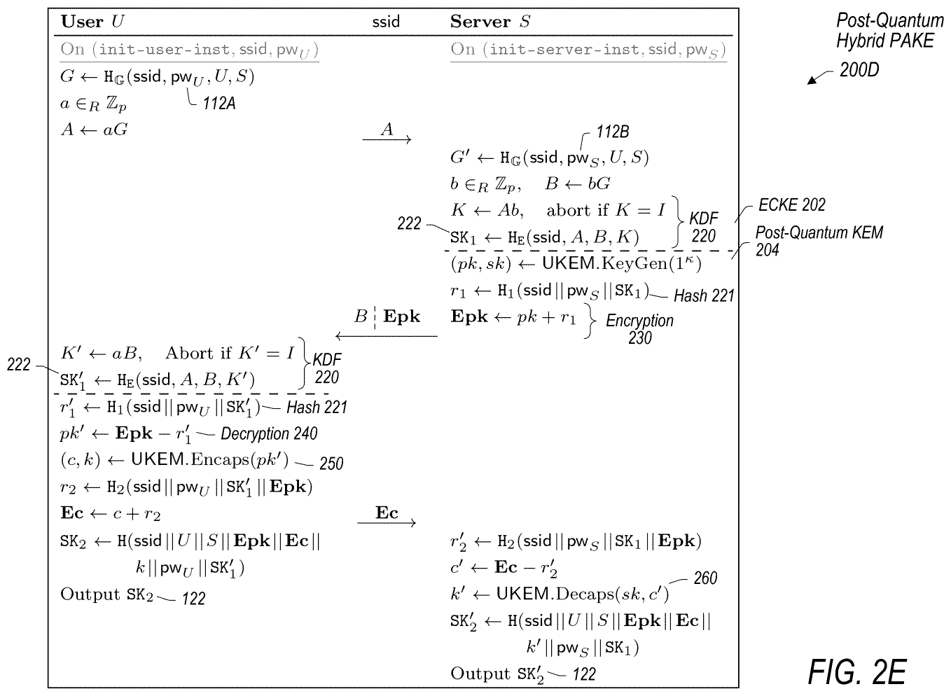

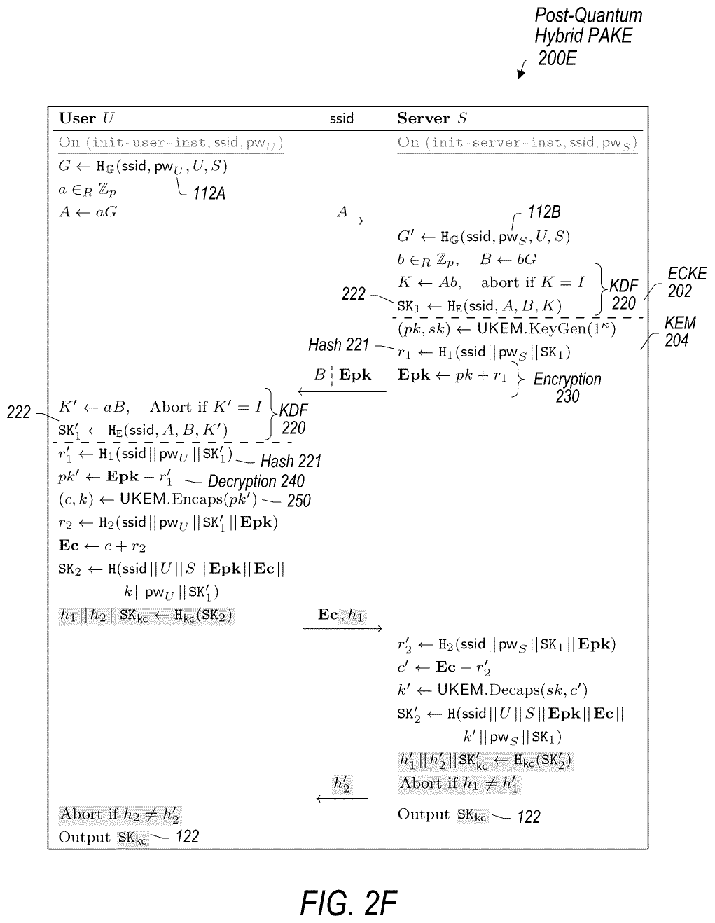

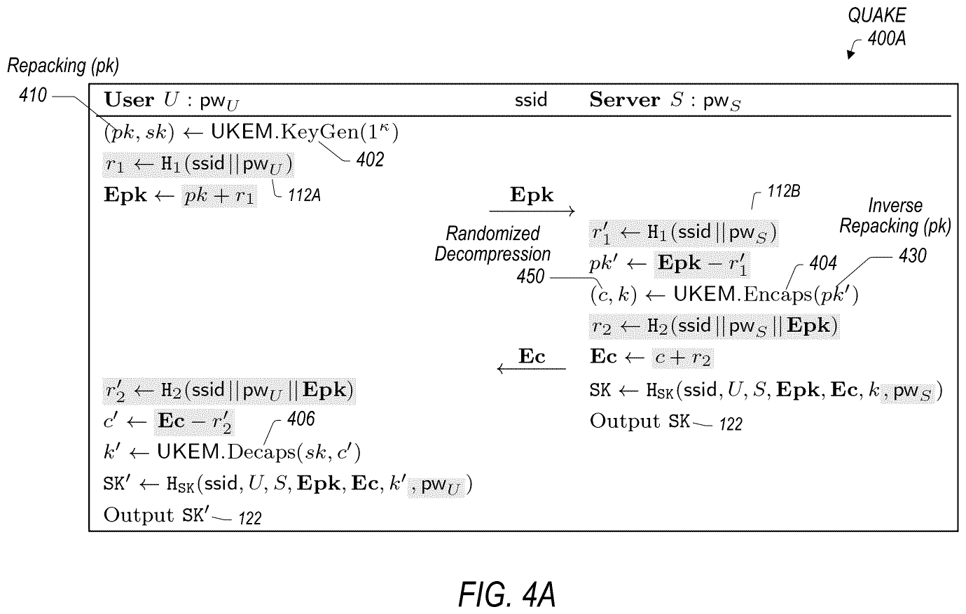

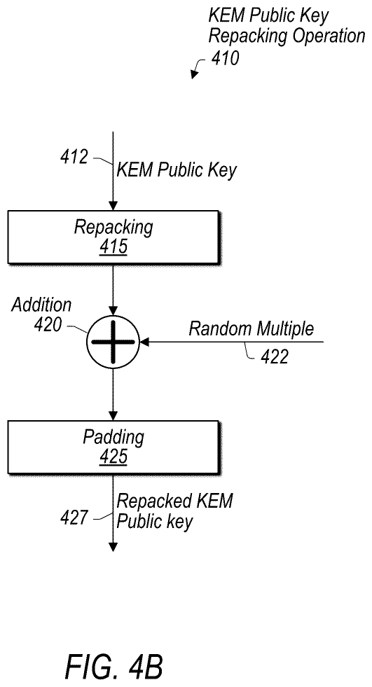

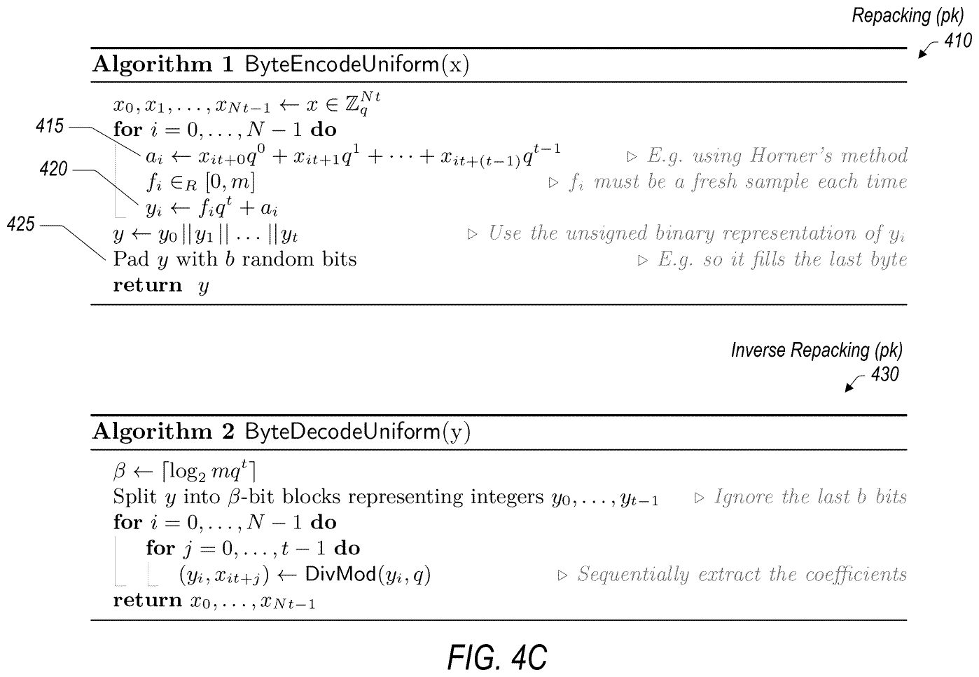

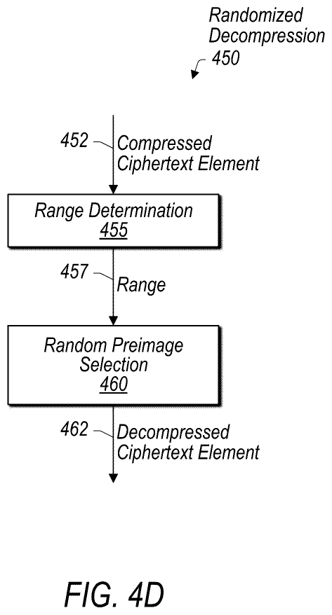

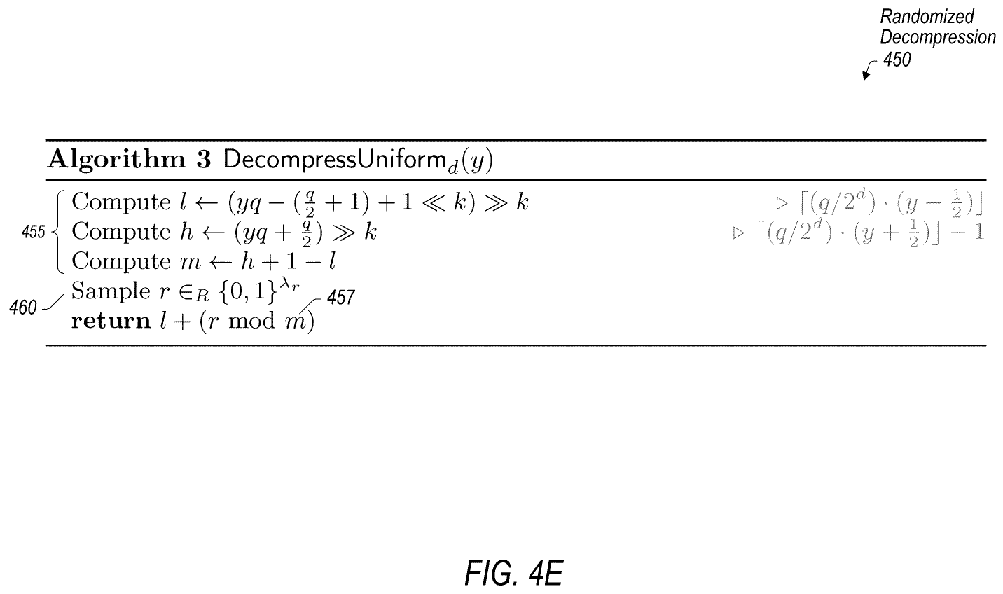

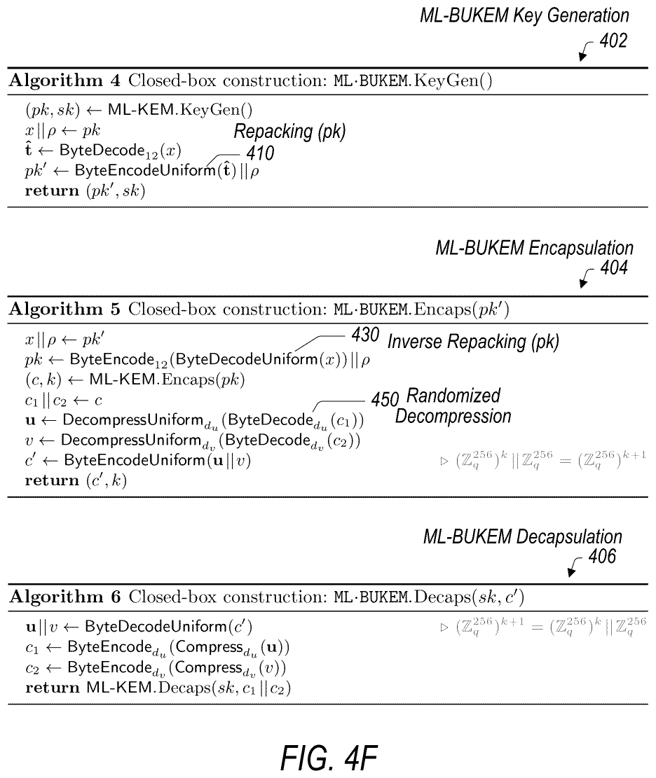

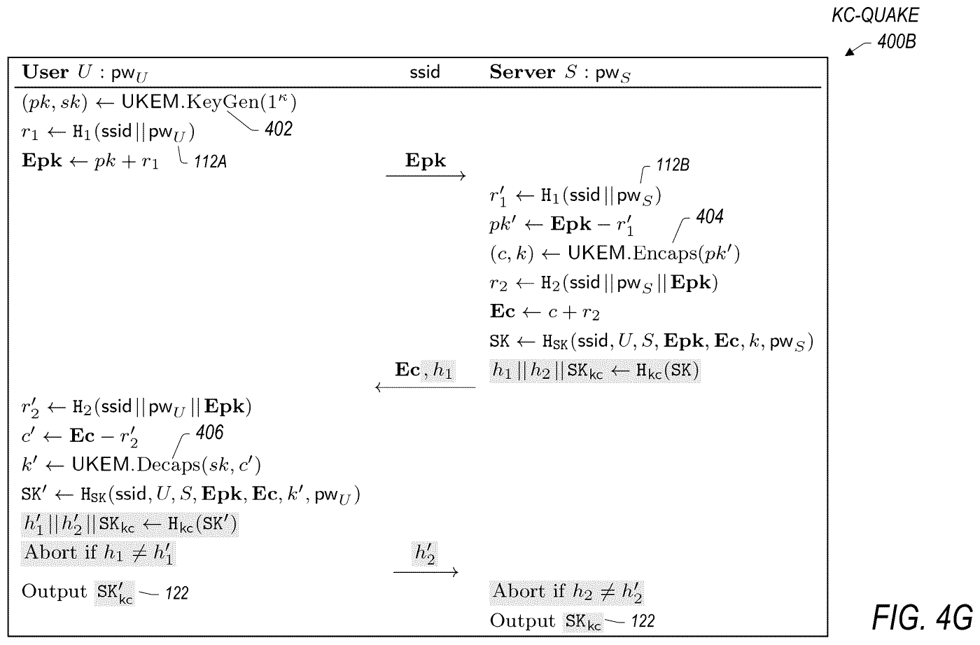

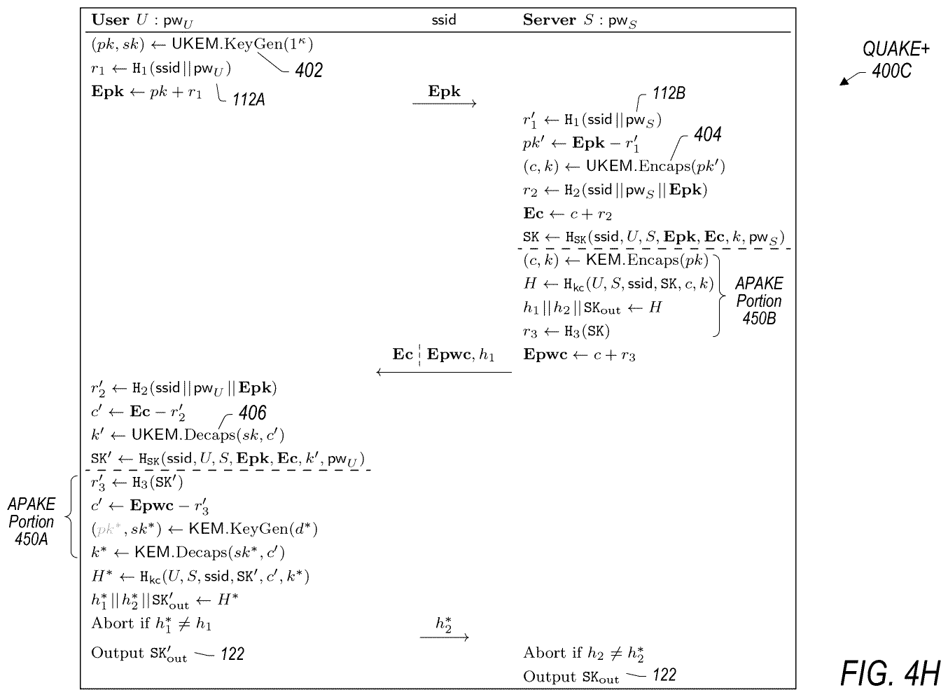

In the illustrated embodiment, devices 100 implement a quantum-resistant PAKE 120 via cryptographic modules 110, which are software, hardware, or combination operable to perform a quantum-resistant PAKE 120. As will be discussed, modules 110 may perform PAKE 120 using a KEM, which is quantum resistant. In some embodiments, the KEM is a lattice-based KEM and may be based on a learning with errors (LWE) algorithm. For example, the KEM may be an ML-KEM such as Kyber, which is part of the Cryptographic Suite for Algebraic Lattices (CRYSTALS). Other KEM examples may include New Hope, Sike, FrodoKEM, NTRU, Saber, etc. Because these KEMs are still being evaluated to assess reliability, quantum-resistant PAKE 120 may be implemented as a hybrid algorithm in which a pre-quantum key exchange is used with a post quantum KEM, so that PAKE 120 is, at least, as secure as the pre-quantum key exchange. As will be discussed with FIGS. 2A-2D, such a hybrid PAKE 120 may use an elliptic-curve key exchange (ECKE) to wrap a post-quantum KEM. PAKE 120 may also be implemented as an augmented PAKE in which server device 100B does not store password 112B and instead stores a persisted public key generated by a KEM based on password 112B. PAKE 120 may also employ other techniques such as repacking and randomized decompression as will be discussed with FIGS. 4A-4C with respect to a uniform KEM.

### Hybrid PAKEs

Turning now to FIG. 2A, an overview block diagram of a post-quantum hybrid PAKE 200 used to implement PAKE 120 is depicted. In the illustrated embodiment, hybrid PAKE 200 includes an initial ECKE 202 portion used to establish an initial secret 222 used to secure a post-quantum KEM 204 portion. In some embodiments, PAKE 200 may be implemented differently than shown. For example, a key exchange other than one based on elliptic curves may be used such as Diffie-Hellman using modular arithmetic, the roles of modules 110A and 110B may be reversed, etc.

As shown, ECKE 202 may begin with user cryptographic module 110A in user device 100A selecting a generator 210A on an elliptic curve based on password 112A while server cryptographic module 110B in user device 100A selects a generator 210B on the elliptic curve based on password 112B. This elliptic curve may correspond to any suitable curve such as Curve25519, Curve448, etc. In various embodiments, modules 110 select a generator 210 based on a password 112 by performing a hash-to-curve map of the password 112. Assuming both passwords 112A and 112B are the same, modules 110 now possess the same selected generator 210. Modules 110 may then select respective elliptic curve (EC) private keys 212A and 212B and multiply them by generators 210 to produce respective EC public keys 214A and 212B. After exchanging EC public keys 214, each module 110 performs a key derivation function (KDF) 220 using its EC private key 212 and the other module 110's exchanged EC public key 214 to produce an initial secret 222. In various embodiments, KDF 220 is an application of elliptic-curve Diffie-Hellman (ECDH). This initial secret 222 may then be used to secure the post-quantum KEM 204 exchange.

Post-quantum KEM 204 may begin with server module 110B generating a KEM public key pair including a KEM public key 232 and a KEM private key 234. In various embodiments, this is performed using a generation function defined by the KEM such as ML-KEM/Kyber.CPA.KeyGen( ) in embodiments in which ML-KEM/Kyber is being used as the KEM or ML-BUKEM.KeyGen( ) as will be discussed below. Server module 110B then performs an encryption 230 of the KEM public key 232 using its derived initial secret 222 and provides the encrypted KEM public key 232 to user module 110A. In response, user module 110A performs a decryption 240 of the encrypted KEM public key 232 using its derived initial secret 222. In various embodiments, encryption 230 and decryption 240 are performed using a symmetric block cipher such as Advanced Encryption Standard (AES).

Once module 110A possess the decrypted KEM public key 232, user module 110A performs an encapsulation 250 of KEM public key 232, which produces a ciphertext 252 and a key. In various embodiments, this is performed using an encapsulation function defined by the KEM such as ML-KEM/Kyber.Encaps( ) in embodiments in which ML-KEM/Kyber is being used as the KEM or ML-BUKEM.Encaps( ) as will be discussed below. In some embodiments, the key output from encapsulation 250 may be used as shared secret 122, which may be used to encrypt communication 140. In other embodiments discussed below, this key may undergo further processing to produce shared secret 122, which may be used to derive one or more additional keys used to encrypt communication 140. As used herein, “using” a cryptographic key to decrypt or encrypt broadly includes 1) decrypting and encrypting with that key, 2) using that key as key material to derive one or more additional keys used to decrypt or encrypt, or 3) using that key to decrypt or encrypt another key used to perform encryption or decryption. Module 110A provides the resulting ciphertext 252 of the encapsulation 250 to module 110B, which performs a decapsulation 260 using the ciphertext 252 and its KEM private key 234. In various embodiments, this is performed using a decapsulation function defined by the KEM such as ML-KEM/Kyber.Decaps( ) or ML-BUKEM.Decaps( ) as will be discussed below. In some embodiments, the key output from decapsulation 260 may be used as shared secret 122; in other embodiments, however, this key may undergo further processing to produce shared secret 122. Post-quantum KEM 204 may also include performance of operations discussed below with FIGS. 4A-H to cause KEM 204 to implement a uniform KEM (UKEM).

Examples of hybrid PAKEs that implement the general flow PAKE 200 will now be discussed.

Turning now to FIG. 2B, a diagram of a post-quantum hybrid PAKE 200A is depicted. As with PAKE 200 above, PAKE 200A may include an initial ECKE 202 portion followed by a post-quantum KEM 204 portion. In some embodiments, PAKE 200A may be implemented differently than shown. For example, the inputs of various hashes may be altered, encryption and decryption operations may be implemented differently such as discussed with FIG. 2C, keys may be derived differently, etc.

PAKE 200A begins in the initial ECKE 202 portion with user module 110A selecting a generator G 210A based on password pwᵤ 112A by performing a hash-to-curve map H_{G} of a shared session identifier (SSID), password pwᵤ 112A, a user identity U, and a server identity S. Module 110A selects a private key a 212A and multiplies it by generator G to produce public key A 214A, which is provided to server module 110B. Server module 110B similarly selects a generator G′ using a hash-to-curve map H_{G} of the SSID, its password pwₛ 112B, U, and S. Server module 110B selects a private key b 212B and multiplies it with G′ to determine a corresponding public key B 214B. Service module 110B performs a KDF 220 that includes performing ECDH using A and b to produce a key K. KDF 220 further includes an encryption hash H_{E} of the SSID, A, B, and K to produce SK₁ corresponding to initial secret 222.

PAKE 200A continues in the post-quantum KEM 204 portion with the server module 110B generating a KEM public key pk 232 and a corresponding KEM private/secret key sk 234. Service module 110B performs an encryption 230 including a first encryption of the public key pk using the SSID concatenated with the server password pwₛ as the encryption key to produce an encrypted KEM public key Epk. Server module 110B then performs a second encryption of Epk with the SK₁, as part of encryption 230, to produce doubly encrypted Epk. Server module 110B then provides its EC public key B and doubly encrypted Epk to user module 110A.

The ECKE 202 portion completes with user module 110A performing KDF 220 using its private key a and the received public key B to produce a key K′, which is hashed as discuss above to produce initial secret SK′₁ 222. User module 110A then performs a decryption 240, which includes a first decryption of Epk using SK×₁ and second decryption of Epk using the SSID concatenated with its password pwᵤ to produce decrypted pk′.

PAKE 200B resumes the post-quantum KEM 204 portion with user module 110A performing an encapsulation 250 using pk′ to produce a ciphertext c 252 and key k. User module 110A performs a key confirmation hash H_{kc} of the SSID, U, S, pwᵤ, Epk, c, and k to produce a hash value H, which is divided into hash value h₁, hash value h₂, and shared secret SK₂ 122. User module 110A encrypts the ciphertext c and hash h₁ using SK′₁ and sends them over to server module 110B.

Server module 110B decrypts the ciphertext c and hash h₁ using SK₁ and performs a decapsulation 260 using the ciphertext and private key sk to extract a key k. Server module 110B hashes the SSID, U, S, pwₛ, Epk, c, and k to produce a hash value H′, which is divided into hash value h₁′, hash value h₂, and shared secret SK′₂ 122. Server module 110B then compares its h₁′ to the decrypted h₁ and outputs SK′₂ if they match indicating both sides input the same passwords 112.

Turning now to FIG. 2C, a diagram of a post-quantum hybrid PAKE 200B is depicted. PAKE 200B is similar to PAKE 200A but differs in performance of KDF 220, encryption 230, and decryption 240. In the illustrated embodiment, the KDF 220 to produce initial secret SK₁ 222 includes using a password 112 as an input into the hashing function H_{E} such that SK₁ is produced by hashing the SSID, pwₛ (or pwᵤ) A, B, and K. Encryption 230 now includes a single encryption of pk using SK₁ to produce Epk. Decryption 240 correspondingly includes a single decryption of Epk using SK₁ to produce pk′.

In some embodiments, PAKE 200B may conclude with h₂ being provided back to the user device 100A for a comparison with its local copy of h₂ as shown in FIG. 2D with a post-quantum hybrid PAKE 200C.

Turning now to FIG. 2E, a diagram of a post-quantum hybrid PAKE 200D is depicted. Post-quantum hybrid PAKE 200D differs from PAKEs 200A-C discussed above primary in its implementation of encryption 230. As shown, PAKE 200D includes performance of a hash operation 221 using initial secret SK₁ (along with the SSID and server password pwₛ) to produce a resulting hash value/mask r₁. This value is then used in encryption 230 to encrypt public key pk via a one-time pad (OTP) encryption by preforming an exclusive OR (XOR) of r₁ and pk to produce Epk. Because OTP cannot be cracked, the security of PAKE 200D can be proven based on a random oracle model approximating the hash function. In contrast, proofs of PAKEs 200A-C use ideal ciphers to approximate encryption 230.

A proof of a cryptographic algorithm based on ideal ciphers can be considered less secure than one based on random oracles due to the inherent differences in their theoretical models. Ideal ciphers are a more restrictive and specific model, representing a perfect block cipher with fixed input and output lengths. This model does not capture the full range of possible cryptographic functions and can be more susceptible to certain types of attacks. On the other hand, the random oracle model assumes the existence of a truly random function that provides a broader and more flexible abstraction, making it a stronger and more versatile foundation for security proofs. This flexibility allows for a wider range of cryptographic constructions and more robust security guarantees, as it better approximates the behavior of real-world cryptographic functions. Consequently, proofs based on random oracles can be seen as providing a higher level of security assurance.

In the illustrated embodiment, initial ECKE 202 portion of PAKE 200D can be implemented in a similar manner as discussed with PAKES 200A-C. After server device 100B provides Epk to user device 100A, device 100A similarly performs a hash 221 of the SSID, the user password pwᵤ, and SK′₁ to produce r′₁, which is used in a decryption 240 that is also using OTP by performing an XOR of r₁ and Epk to produce pk′. An encapsulation 250 of the pk′ is performed to produce a ciphertext c and key k. In some embodiments, encapsulation 250 (as well as the key generation and decapsulation 260) is performed using a UKEM such as discussed below. Another hash H₂ of the SSID, pwᵤ, SK′₁, and Epk is performed to produce a hash value result r₂. The ciphertext c is then encrypted using r₂ via OTP to produce an encrypted ciphertext Ec, which is provided to server device 100B. User device 100A may then derive shared secret SK₂ by hashing the SSID, the user identity U, the server identity S, Epk, Ec, k, pwᵤ, and SK′1.

In response to receiving encrypted ciphertext Ec, server device 100B determines r′₂ by performing hash H₂ using the SSID, pwₛ, SK₁, and Epk. Ec is then decrypted using r′₂ via OTP. Server device 100B performs a decapsulation 260 of ciphertext c′ using the corresponding secret key sk to produce key k′. Server device 100B then similarly derives shared secret SK′₂ by hashing the SSID, the user identity U, the server identity S, Epk, Ec, k′, pwᵤ, and SK1.

In some embodiments, PAKE 200D further includes user device 100A generating hash values h₁ and h₂ from SK₂ and providing h₁ to server device 100B for a comparison with locally generated copy of h₁ as shown in FIG. 2F with a post-quantum hybrid PAKE 200E. Server device 100B may further provide a locally generated copy of h₂ for comparison by user device 100A with its copy of h₂.

### Augmented PAKEs

In the hybrid PAKES 200 discussed above, server device 110B uses its password 112B as an input into the PAKE. Storing multiple passwords 112B, however, creates an additional vulnerability if these passwords 112 are ever compromised as they could allow an attacker to masquerade as a user device 100A. To avoid storing these passwords 112, a PAKE 120 may be transformed into an APAKE as will be discussed next.

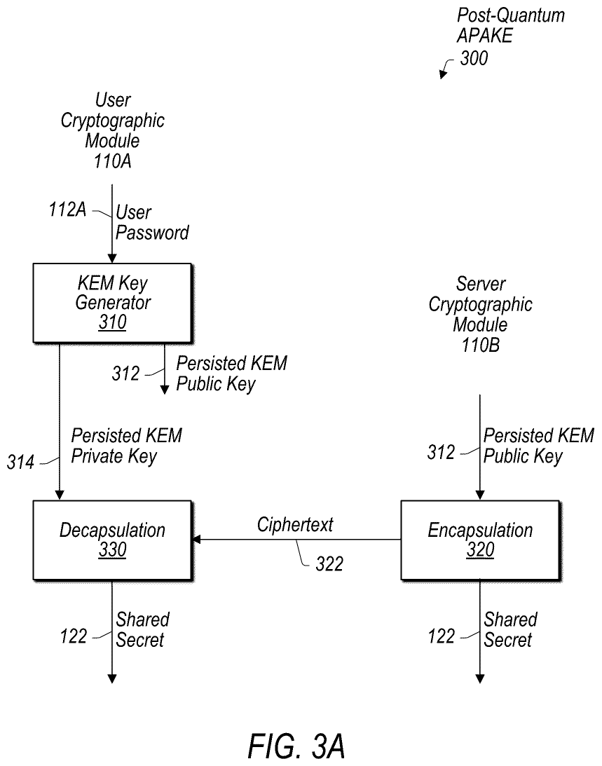

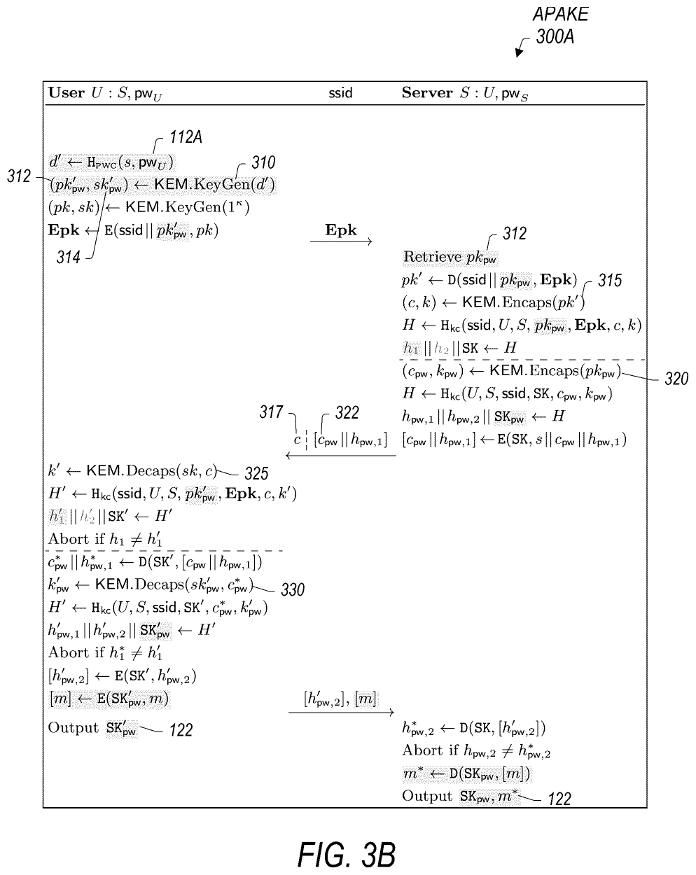

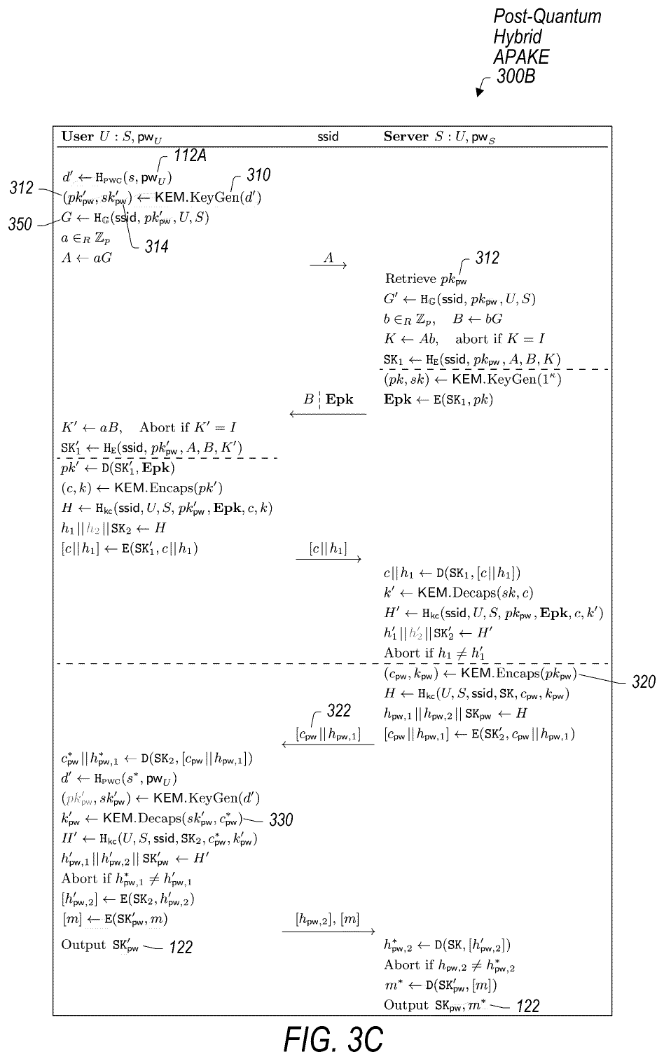

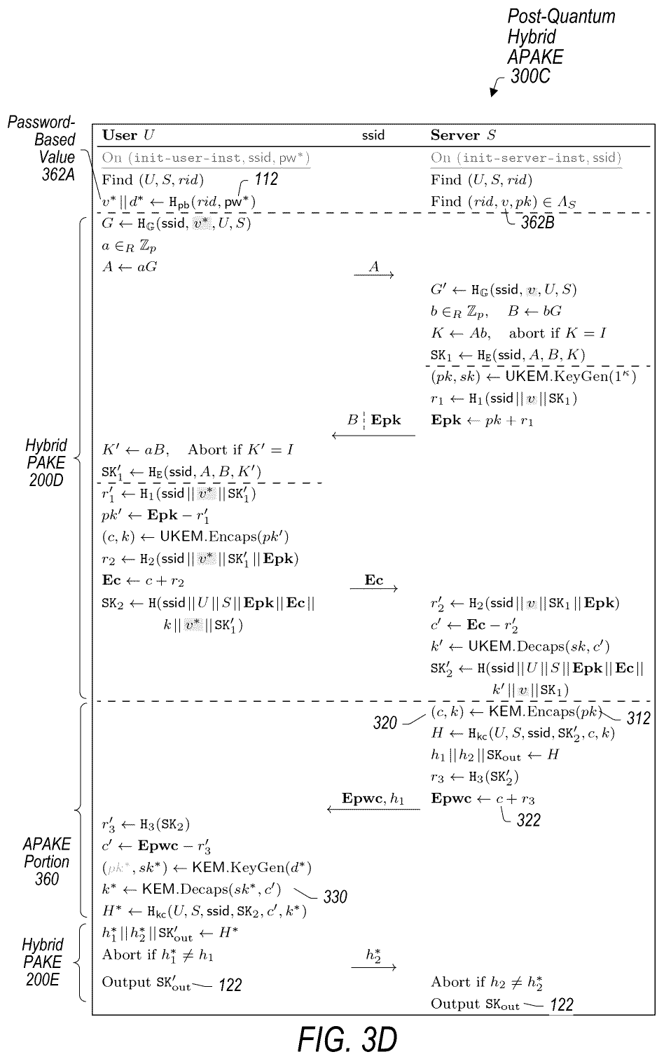

Turning now to FIG. 3A, an overview block diagram of a post-quantum APAKE 300 used to implement PAKE 120 is depicted. In the illustrated embodiment, PAKE 300 is a PAKE that forgoes storage of password 112B at server device 100B and, instead, is transformed into an APAKE by preserving password information at server device 100B in the form of a persisted public key 312 derived based on password 112.

As shown, APAKE 300 includes a user module 110A inputting a user password 112A into a KEM key generator 310, such as Kyber.CPA.KeyGen( ) to produce a persisted KEM public key 312 and a persisted KEM private key 314. During the initial performance of APAKE 300, server module 110B may perform the same inputting of its server password 112B into KEM key generator 310 to produce persisted KEM public key 312 and persisted KEM private key 314. Server module 110B stores persisted KEM public key 312 and uses it in lieu of storing password 112B. Accordingly, when APAKE 300 is performed again, server module 110B merely retrieves persisted KEM public key 312 and begins performing its portion of APAKE 300. Thus, if persisted KEM public key 312 is ever compromised, a malicious actor may know key 312 but is unable to easily determine password 112.

After retrieving persisted KEM public key 312, server module 110B performs an encapsulation 320, such as Kyber.Encaps( ) using the persisted KEM public key 312 to produce a ciphertext 322 and a key. Server module 110B provides this ciphertext 322 to user module 110A. User module 110A then performs a decapsulation 330, such as Kyber.Decaps( ) using ciphertext 322 and persisted KEM private key 314. In some embodiments, the keys output from encapsulation 320 and decapsulation 330 may be used as shared secret 122; in other embodiments, however, these keys may undergo further processing to produce shared secret 122 as will be discussed.

Examples of APAKEs that implement the general flow PAKE 300 will now be discussed.

Turning now to FIG. 3B, a diagram of a post-quantum APAKE 300A is depicted. In the illustrated embodiment, APAKE 300A does not include ECKE portion as with PAKEs 200 and, instead, uses a combination of persisted and ephemeral KEM public key pairs to establish a shared secret 122. In some embodiments, PAKE 300A may be implemented differently than shown. For example, the inputs of various hashes may be altered, encryption and decryption operations may be implemented differently, keys may be derived differently, etc.

APAKE 300A begins with user module 110A performing a password confirmation hash H_{pwc} of a salt s and password pwᵤ 112A to produce a hash value d′. Module 110A inputs this hash value d′ into the key generator 310 to produce a persisted KEM public key pk′_{pw} 312 and persisted KEM private key sk′_{pw} 314. Module 110A also uses the generator 310 to produce an ephemeral public key pair pk, sk. Module 110A then encrypts the ephemeral public key pk using the SSID concatenated with the persisted public key pk′_{pw} to produce an encrypted Epk provided to server module 110B.

In response to receiving Epk, Server module 110B retrieves a previously stored copy of a persisted KEM public key pk_{pw} 312 and uses it and the SSID to decrypt Epk to produce decrypted pk′. Server module 110B performs an encapsulation using pk′ to produce a ciphertext c 317 and a key k. Server module 110B performs a key confirmation hash H_{kc} of the SSID, U, S, pk_{pw}, Epk, c, and k to produce a hash value H, which is divided into hash value h₁, hash value h₂, and key SK. Server module 110B performs a second encapsulation 320 using pk_{pw} to produce a ciphertext c_{pw} 322 and a key k_{pw}. Server module 110B performs a second key confirmation hash H_{kc} of U, S, the SSID, SK, c_{pw}, and k_{pw} to produce another hash value H, which is divided into hash value h_{pw,1}, hash value h_{pw,2}, and shared secret SK_{pw} 122. Secure module 110B then uses SK to encrypt s, c_{pw}, h_{pw,1} and send the encrypted values and the ciphertext c over to user module 110A.

User module 110A performs a decapsulation 325 using the ciphertext c and the ephemeral private key sk to produce a key k′. User module 110A performs a key confirmation hash H_{kc} of the SSID, U, S, pk′_{pw}, Epk, c, and k′ to produce a hash value H′, which is divided into hash value h′₁, hash value h′₂, and key SK′. APAKE 300A is aborted if h₁ and h′₁ are not equal. User module 110A decrypts c_{pw} and h_{pw,1} using SK′ and performs a decapsulation 330 using persisted private key sk_{′pw} and c_{pw} to the key k′_{pw}. User module 110A performs a second key confirmation hash H_{kc} of U, S, the SSID, SK′, c_{pw}, and k′_{pw} to produce another hash value H′, which is divided into hash value h′_{pw,1}, hash value h′_{pw,2}, and shared secret SK′_{pw} 122. APAKE 300A is aborted if h_{pw,1} and h′_{pw,1} are not equal. User module 110A then encrypts h′_{pw,2} using SK′ and a message m using SK′_{pw}, which are sent over to server module 110B for verification.

Server module 110B decrypts h′_{pw,2} using SK and m using SK_{pw} 122. APAKE 300A is aborted if h_{pw,2} and h′_{pw,2} are not equal. Otherwise, server module 110B outputs m and SK_{pw} 122 for use in securing communication 140.

Turning now to FIG. 3C, a diagram of a post-quantum APAKE 300B is depicted. In the illustrated embodiment, APAKE 300B is a hybrid PAKE that employs aspects of PAKEs 200 discussed above. APAKE 300B, however, uses persisted KEM public key as an input into the ECKE portion performed by server module 110B instead of using password 112B. In some embodiments, PAKE 300B may be implemented differently than shown. For example, user module 110A may not generate persisted KEM key pair pk_{pw} and sk_{pw} twice, the inputs of various hashes may be altered, encryption and decryption operations may be implemented differently, keys may be derived differently, etc.

APAKE 300B begins with user module 110A performing a password confirmation hash H_{pwc} of a salt s and password pwᵤ 112A to produce a hash value d′. Module 110A inputs this hash value d′ into the key generator 310 to produce a persisted KEM public key pk′_{pw} 312 and persisted KEM private key sk′_{pw} 314. User module 110A then performs an ECKE that includes selecting a generator G 350 based on a persisted KEM public key pk′_{pw} 312 by performing a hash-to-curve map H_{G} of the SSID, pk′_{pw}, a user identity U, and a server identity S. User module 110A selects an EC private key a and multiplies it by the generator 350 to produce an EC public key A, which it provides to server module 110B.

Server module 110B retrieves its copy of the persisted KEM public key pk_{pw} 312 and selects the same generator G′ 350 based on pk_{pw} 312 by performing a hash-to-curve map H_{G} of the SSID, pk_{pw}, a user identity U, and a server identity S. Server module 110B selects an EC private key b and multiplies it by the generator 350 to produce an EC public key B. Server module 110B performs a KDF including an ECDH of A and b to produce a key K. Server module 110B then performs a generator hash H_{g} of the SSID, pk_{pw}, A, B, and K to produce an initial secret SK₁. Server module 110B generates an ephemeral KEM public key pk and a corresponding ephemeral KEM private/secret key sk. Server module 110B encrypts pk using SK1 to produce Epk, which is provided along with B to user module 110A.

User module 110A performs a KDF that includes an ECDH of a and B to produce a key K′ and performs a generator hash H_{g} of the SSID, pk′_{pw}, A, B, and K′ to produce an initial secret SK′₁. User module 110A decrypts Epk using SK′₁ to produce pk′ and performs first encapsulation using pk′ to produce a ciphertext c and a key k. User module 110A performs a key confirmation hash H_{kc} of the SSID, U, S, pk′_{pw}, Epk, c, and k to produce a hash value H, which is divided into hash value h₁, hash value h₂, and key SK₂. Module 110A encrypts c concatenated with h₁ using SK′₁ and sends them over to server module 110B.

Server module 110B decrypts c and h₁ using SK₁ and performs a first decapsulation using c and ephemeral KEM private key sk to produce a key k′. Server module 110B performs a key confirmation hash H_{kc} of the SSID, U, S, pk_{pw}, Epk, c, and k′ to produce a hash value H, which is divided into hash value h′₁, hash value h′₂, and key SK′₂. APAKE 300B is aborted if h₁ and h′₁ are not equal. Server module 110B performs a second encapsulation 320 using pk_{pw} 312 to produce a ciphertext c_{pw} and a key k_{pw}. Server module 110B performs a second key confirmation hash H_{kc} of U, S, the SSID, SK, c_{pw}, and k_{pw} to produce another hash value H, which is divided into hash value h_{pw,1}, hash value h_{pw,2}, and shared secret SK_{pw} 122. Secure module 110B then uses SK′2 to encrypt c_{pw} and h_{pw,1} and sends the encrypted them over to user module 110A.

User module 110A uses SK₂ to decrypt c_{pw} and h_{pw,1}. User module 110A may regenerate pk′_{pw} and sk′_{pw} as discussed above and performs a second decapsulation 330 using sk′_{pw} and c_{pw} to produce k′_{pw}. User module 110A performs a second key confirmation hash H_{kc} of U, S, the SSID, SK₂, c_{pw}, and k′_{pw} to produce another hash value H′, which is divided into hash value h′_{pw,1}, hash value h′_{pw,2}, and shared secret SK′_{pw} 122. APAKE 300A is aborted if h_{pw,1} and h′_{pw,1} are not equal. User module 110A then encrypts h′_{pw,2} using SK′ and a message m using SK′_{pw}, which are sent over to server module 110B for verification.

Server module 110B decrypts h′_{pw,2} using SK and m using SK_{pw} 122. APAKE 300A is aborted if h_{pw,2} and h′_{pw,2} are not equal. Otherwise, server module 110B outputs m and SK_{pw} 122 for use in securing communication 140.

Turning now to FIG. 3D, a diagram of a post-quantum hybrid APAKE 300C is depicted. In the illustrated embodiment, APAKE 300C implements aspects of hybrid PAKEs 200D and 200E (as well as the UKEMs discussed below with FIGS. 4A-4H in some embodiments) but includes an APAKE portion 360 enabling server device 100B to forgo storing its password pwₛ. Instead, APAKE 300C begins with user device 100A deriving a password-based value v* 362A by performing a hash H_{pb} of a reusable identifier rid and its password pwᵤ. Server device 100B similarly computes the password derived value v 362B using rid and pwₛ. When the portion corresponding to hybrid PAKE 200D is performed, APAKE 300C uses v* and v in lieu of pwₛ and pwd. In some embodiments, this can allow server to merely store v and reuse v during a subsequent performance of the PAKE 200D portion. In other embodiments, server device 100B can merely store SK′2 and pk (as persisted KEM public key 312) and perform APAKE 300C again starting at APAKE portion 360.

As shown, APAKE portion 360 begins with server device 100B performing an encapsulation 320 using pk 312 to produce a ciphertext c and key k. Server device 100B performs a hash H_{kc} of U, S, the SSID, SK′2, c, and k. Server device 100B separates out h₁, h₂, and SKₒᵤₜ from the resulting hash value. Server device 100B performs a hash H₃ of SK′₂ to produce result/mask r₃ and encrypts ciphertext c using r₃ via OTP to produce Epwc, which is sent with h₁ to user device 100A. User device 100A reproduces r′₃ from hashing SK₂ and decrypts c′ via OTP. User device 100A regenerates sk* and performs a decapsulation 330 of c′ using sk* to produce k*. User device 100A performs a hash H_{kc} of U, S, the SSID, SK₂, c′, and k*. User device 100A separates h₁*, h₂*, and SK′ₒᵤₜ from the result and then performs a hash value comparison as in hybrid PAKE 200E discussed above.

### Quantum Uniform Authenticated Key Exchanges (QUAKEs)

Some post-quantum KEMs, such as ML-KEM, perform a compression operation when generating KEM public key pairs and when performing a KEM encapsulation in order to reduce the sizes of the keys and the corresponding ciphertext. While these keys and ciphertext appear uniform when represented in integer form, this is not the case when the keys and ciphertext are converted to binary as performance of the compression operation includes multiple arithmetic operations performed modulo a prime number q, which is not close to a power of two (e.g., q being 3329 in ML-KEM). This bit-sequence non-uniformity is problematic as it causes the number of possible preimages to differ between compressed elements and causes the KEM to not be anonymous. It is also problematic as it can make the KEM keys distinguishable from random data, which can result in the KEM being insecure. A PAKE using such a KEM, however, can be modified to mitigate this issue as will be discussed.

Turning now to FIG. 4A, a diagram of a QUAKE 400A used to implement PAKE 120 is depicted. As will be discussed, QUAKE 400A incorporates usage of a Module-Lattice based binary uniform KEM (ML-BUKEM). As used herein, a UKEM is a key encapsulation mechanism that provides IND-CCA2 security and has two more properties: both the public keys and ciphertexts that they generate are computationally indistinguishable from uniformly-random samples from their respective spaces. As used herein, BUKEM is a UKEM in which these properties extend to the public keys and ciphertexts when they are represented as bitstrings of a given length.

As shown, QUAKE 400A can include user module 110A performing a UKEM key generation 402, such as UKEM.KeyGen( ) discussed with FIG. 4F, to produce a KEM public key pk and a KEM private key sk. QUAKE 400A also includes server module 110B performing encapsulation 404 using pk to produce a ciphertext c. As just noted, if ML-KEM.KeyGen( ) and ML-KEM.Encaps( ) are merely used, these two operations 402 and 404 include performance of a compression that results in pk and c not having uniform bit sequences, which can still be apparent in Epk and Ec when they are encrypted using a potentially weaker key such as the SSID and password pwᵤ.

To address the first issue with KEM key generation in the illustrated embodiment, UKEM.KeyGen( ) 402 has been modified to include a repacking operation 410 of public key pk, discussed with FIG. 4B, when pk is generated to cause pk to have a uniform bit sequence. The repacked version the public key can then be encrypted via OTP (as discussed above) to produce Epk for transition to server module 110B. Server module 110B can then decrypt Epk via OTP using the SSID and password pwₛ. UKEM.Encaps( ) 404 then includes performance of an inverse repacking 430 of pk to return it to its original form when performing an encapsulation.

To address the second issue with KEM encapsulation in the illustrated embodiment, UKEM.Encaps( ) 404 further includes a randomized decompression 450 of ciphertext c's elements, discussed with FIG. 4C, when c is produced by the encapsulation. Server module 110B can then encrypt the modified ciphertext c elements via OTP to produce Ec and can provide Ec to user module 110A for decryption via OTP and decapsulation 406 to produce a shared secret/key SK. In some embodiments, ciphertext c may also undergo a repacking operation 410 and inverse repacking 430 similar to public key pk.

Turning now to FIG. 4B, a block diagram of a KEM public key repacking operation 410 is depicted. In the illustrated embodiment, repacking operation 410 includes a repacking 415, addition 420, and padding 425.

Repacking 415 repacks elements of a KEM public key 412 received from a KEM generation into a base-q integer having an ordering such that a first element is the least significant and a last element is the most significant, the base-q integer now being within a first range of [0, q′) where q is the KEM's prime (e.g., 3329) and t is the elements in one integer. In some embodiments, repacking 415 uses Horner's method.

Addition 420 adds, to the repacked elements, a random multiple 422 of a maximum of the first range. If random multiple 422 is within a second range [0, m) (m being the maximum range of factor), then the resulting base-q integer is in the range [0, m·q^{t}). m is chosen such that m·q^{t} is within a particular threshold of a power of two. As a result, the binary encoding of the base-q integer is now very close to uniform. Thus, the second range is chosen such that a multiplication of a maximum of the first range [0, q^{t}) and a maximum of the second range [0, m) is within the particular threshold of a power of two. In some embodiments, this particular threshold is defined as a threshold of 2⁻⁴⁰: (<Next Power of two>−the multiplication result)/<Next Power of two><2⁻⁴⁰.

While the binary encoding is already a sequence of bits that is close to uniform, padding 425 is performed to pad a result of the addition 420 to have a length equal to a multiple of a cipher block size associated with the KEM (e.g., 256 bits per block) to produce a repacked version of the public key 427. In particular, padding 425 appends b random bits to pad the sequence of bits until it reaches this correct length.

In embodiments in which the KEM is ML-KEM, a public key in ML-KEM includes k·n elements, k being the security parameter and n being the number of polynomial coefficients. At is chosen that divides this number, which allows the public key to be fully packed into k·n/t integers. After these steps 415-425, the bit length of a repacked public key λₚₖ is t·[log₂(k·n)]+b.

An example of a first algorithm implementing repacking operation 410 is depicted in FIG. 4C and shown as the function ByteEncodeUniform(x). An example of a second algorithm implementing the inverse repacking operation 430 is also depicted and shown as the function ByteDecodeUniform(y).

Turning now to FIG. 4D, a block diagram of a randomized decompression 450 is depicted. In the illustrated embodiment, decompression 450 receives a compressed ciphertext element 452 in Z₂_{^{d}} (the scaler group of order 2^{d}) and outputs a random preimage (shown as decompressed ciphertext element 462) for it in Z_{q} (the scaler group of order q). This preimage may be sampled uniformly from all possible preimages to ensure that the final ciphertext is again uniformly distributed. After applying randomized decompression 450 to all elements in a compressed ciphertext, the decompressed ciphertext can be repacked using repacking operation 410.

In the case of ML-KEM, ML-KEM's decompression takes in an element y E Z₂_{^{d}} and outputs x′←┌(q/2^{d})·y┘∈Z_{q}. Notice that x is deterministic, but the original preimage x could have been in the range [┌(q/2^{d})·(y−1/2)┘, ┌(q/2^{d})·(y+1/2)┘), taking into account modulus q. Rather than performing rejection sampling, decompression 450 includes a range determination 455 to compute this range 457. A random preimage selection 460 is performed to pick a random preimage 462 by sampling a large random integer and reducing it such that it falls in this range. A benefit of decompression 450 is that it can run in constant time. If the random number is large enough, the bias is negligible.

An example of a third algorithm implementing randomized decompression 450 is depicted in FIG. 4E and shown as the function DecompressUniform_{d}(y).

Turning now to FIG. 4F, example algorithms for performing ML-BUKEM operations 402-406 are depicted. In the illustrated embodiment, key generation 402 includes performance of ML-KEM.KeyGen( ) to produce an initial version of public key pk, which is then repacked (specifically the x component) via operation 410 to produce pk′ returned by the operation. Encapsulation 404 performs inverse repacking 430 of pk′ (specifically the x component) and then ML-KEM.Encaps(pk) to ciphertext c. Encapsulation 404 further includes performing randomized decompression 450 on subcomponents c₁ and c₂. Their results then undergo repacking 410. Decapsulation 406 performs an inverse repacking 430 of the received ciphertext c before performing ML-KEM.Decaps. using the result to return the result.

Various ones of the PAKEs discussed above (or other suitable PAKEs) may incorporate operations 410-450. Two additional PAKEs including these features will now be discussed.

Turning now to FIG. 4G, a diagram of another QUAKE 400B (shown as KC-QUAKE) is depicted. In the illustrated embodiment, KC-QUAKE is implemented in a similar manner as QUAKE 400A but further includes the exchanges of hash values h1 and h2 derived from shared key SK/SK′ in order to allow user device 100A and server device 100B to quickly determine whether SK and SK′ match as both the parties would have no way of knowing whether their key exchange succeeded until they attempted to exchange information encrypted using the keys. In particular, server device 100B determines a hash H_{kc} of SK to produce the concatenation of h₁, h₂, and SK_{kc}. Server device 100B then provides h₁ to user device 100A, which produces a corresponding set of h₁′, h₂′ and SK_{kc}. If a comparison of h₁ and h₁′ is successful, user device 100A outputs SK′_{kc} as shared secret 122. Server device 100B receives h′₂ from user device 100A and outputs SK_{kc} if h₂ matches h′₂.

Turning now to FIG. 4H, a diagram of another QUAKE 400C (shown as QUAKE+) is depicted. In the illustrated embodiment, QUAKE+ is a modified version of QUAKE 400A that includes APAKE portions 450 to implement an APAKE. During an initial performance of QUAKE+, server device 100B may perform QUAKE 400A as previously discussed in which server device 100B eventually produces a shared key SK by performing a hash Hsk of the SSID, U, S, Epk, Ec, k, and pwₛ. Server device 100B can then store Ec, SK and pk (as opposed to pwₛ) for a subsequent performance of QUAKE+ and not perform the initial QUAKE 400A portion above the APAKE portion 450B.

Accordingly, when QUAKE+ is performed again, server device 100B performs APAKE portion 450B in which device 100B performs an KEM encapsulation of pk to produce ciphertext c and key k. Device 100B performs a hash H_{kc} of U, S, the SSID, SK, c, and k. From this hash result, device 100B separates out h₁, h₂, and SKₒᵤₜ to perform the hash comparison discussed above with KC-QUAKE. Server device 100B then performs a hash H₃ of SK to produce r₃, which used to encrypt ciphertext c via OTP to produce Epwc. Server device 100B sends Ec, Epwc, and h₁ to user device 100A. Device 100A then decrypts Ec using OTP as discussed above with QUAKE 400A and decapsulates it to produce k′ and then SK′. User device 100A then performs a corresponding APAKA portion 450A in which r′3 is produced by performing a hash H₃ of SK′ and decrypting Epwc using r′₃ via OTP. User device 100A then regenerates sk* to decapsulate c′ to produce k*, which is hashed using H_{kc} as discussed to eventually produce SK′ₒᵤₜ as shared secret 122.

### Methods

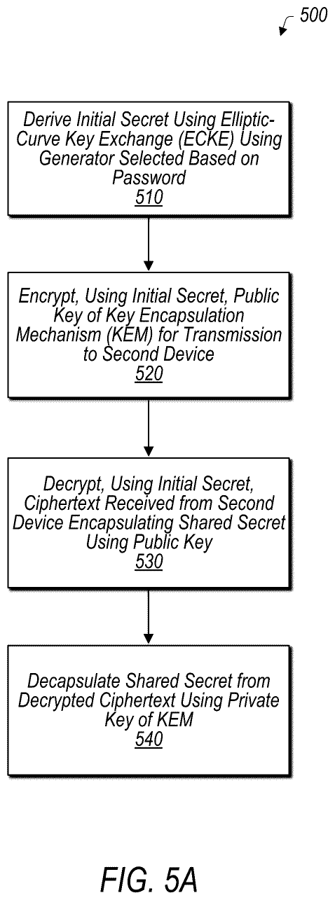

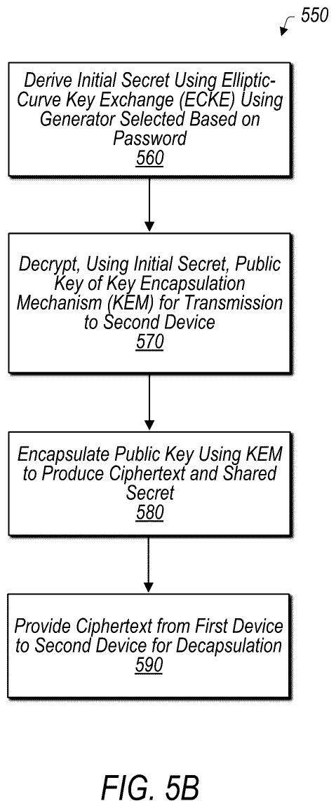

Turning now to FIG. 5A, a flow diagram of a method 500 is depicted. Method 500 is one embodiment of a method to establish a shared secret for secure communication between a first device and a second device, such as devices 100A and 100B, using a hybrid password-authenticated key exchange (PAKE)

The hybrid PAKE begins in step 510, with deriving an initial secret (e.g., initial secret 222) using an elliptic-curve key exchange (ECKE) (e.g., ECKE 202) using a generator (e.g., generator 210B) selected based on a password (e.g., server password 112B). In step 520, the hybrid PAKE includes encrypting (e.g., via encryption 230), using the initial secret, a public key of a key encapsulation mechanism (KEM) for transmission to the second device. In various embodiments, the encrypting uses the initial secret and the password. In some embodiments, the encrypting includes a first encryption of the public key using the password and a second encryption of the public key using the initial secret. In some embodiments, the encrypting includes hashing the initial secret and the password to produce a hashed key and encrypting the public key using the hashed key. In step 530, the hybrid PAKE includes decrypting, using the initial secret, a ciphertext received from the second device encapsulating (e.g., encapsulation 250) the shared secret using the public key. In step 540, the hybrid PAKE includes decapsulating (e.g., decapsulation 260) the shared secret from the decrypted ciphertext using a private key of the KEM. In some embodiments, the hybrid PAKE further includes hashing the decapsulated shared secret with the password to establish the shared secret. In various embodiments, method 500 includes establishing a secure communication channel with the second device using the established shared secret and providing data to the second device via the established secure communication channel.

Turning now to FIG. 5B, a flow diagram of a method 550 is depicted. Method 550 is another embodiment of a method to establish a shared secret for secure communication between a first device and a second device, such as devices 100A and 100B, using a hybrid password-authenticated key exchange (PAKE).

The hybrid PAKE begins in step 560 with deriving an initial secret (e.g., initial secret 222) using an elliptic-curve key exchange (ECKE) (e.g., ECKE 202) using a generator selected based on a password. In step 570, the hybrid PAKE includes decrypting (e.g., decryption 240), using the initial secret, a public key of a key encapsulation mechanism (KEM) for transmission to the second device. In some embodiments, the decrypting uses the initial secret and the password. In some embodiments, the decrypting includes a first decryption of the public key using the password and a second decryption of the public key using the initial secret. In some embodiments, the decrypting includes hashing the initial secret and the password to produce a hashed key and decrypting the public key using the hashed key. In step 580, the hybrid PAKE includes encapsulating (e.g., encapsulation 250) the public key using the KEM to produce a ciphertext and the shared secret. In step 590, the hybrid PAKE includes providing the ciphertext (e.g., ciphertext 252) from the first device to the second device for decapsulation. In some embodiments, the hybrid PAKE further includes hashing the produced shared secret with the password to establish the shared secret. In various embodiments, method 550 includes establishing a secure communication channel with the second device using the established shared secret and providing data to the second device via the established secure communication channel.

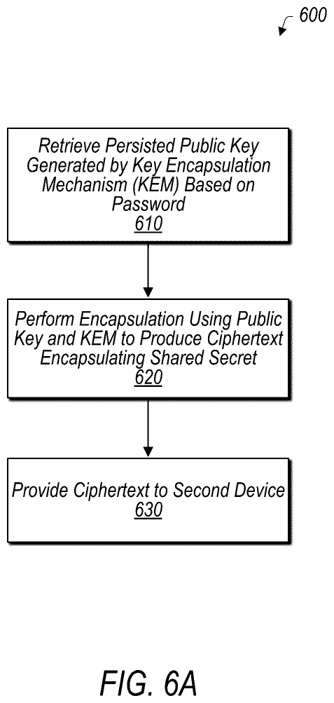

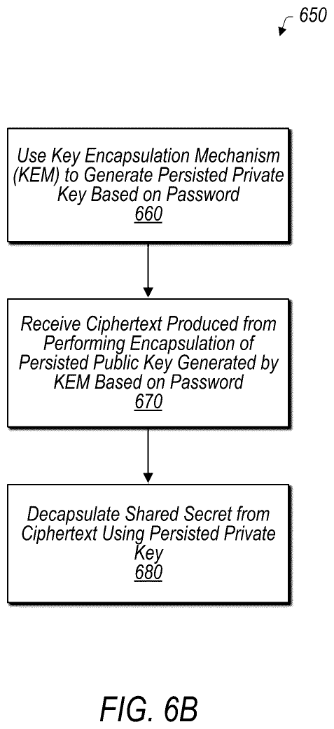

Turning now to FIG. 6A, a flow diagram of a method 600 is depicted. Method is 600 is one embodiment of a method to establish a shared secret for secure communication between a first device and a second device, such as devices 100A and 100B, using an augmented password-authenticated key exchange (APAKE).

The APAKE begins in step 610 with retrieving a persisted public key (e.g., key 312) generated by a key encapsulation mechanism (KEM) based on a password. In step 620, the APAKE includes performing an encapsulation (e.g., encapsulation 320) using the persisted public key and the KEM to produce a ciphertext encapsulating the shared secret. In step 630, the APAKE includes providing the ciphertext to the second device. In various embodiments, the APAKE further includes decrypting a received ephemeral public key using the persisted public key, performing a second encapsulation (e.g., encapsulation 315) using the ephemeral public key and the KEM to produce a second ciphertext, and providing the second ciphertext (e.g., ciphertext 317) to the second device. In some embodiments, the APAKE further includes deriving the shared secret based on keys produced from the encapsulations using the persisted and ephemeral public keys. In various embodiments, the APAKE further includes deriving an initial secret using an elliptic-curve key exchange (ECKE) using a generator (e.g., generator 350) selected based on the persisted public key and encrypting, using the initial secret, an ephemeral public key of the KEM for transmission to the second device. In some embodiments, the APAKE further includes deriving the shared secret based on keys produced from the encapsulation using the persisted public key and a decapsulation using a ciphertext produced from an encapsulation using the ephemeral public key and the KEM. In various embodiments, method 600 includes establishing a secure communication channel with the second device using the established shared secret and providing data to the second device via the established secure communication channel.

Turning now to FIG. 6B, a flow diagram of a method 650 is depicted. Method 650 is another embodiment of a method to establish a shared secret for secure communication between a first device and a second device, such as devices 100A and 100B, using an augmented password-authenticated key exchange (APAKE).

The APAKA begins in step 660 with using a key encapsulation mechanism (KEM) to generate (e.g., via generator 310) a persisted private key (e.g., persisted KEM private key 314) based on a password. In step 670, the APAKA includes receiving a first ciphertext (e.g., ciphertext 322) produced from performing an encapsulation (e.g., encapsulation 320) using a persisted public key generated by the KEM based on the password. In step 680, the APAKA includes performs a decapsulation (e.g., decapsulation 330) using the first ciphertext and the persisted private key to produce the shared secret. In various embodiments, the APAKE further includes encrypting an ephemeral public key using the persisted public key for transmission to the second device and performing a second decapsulation (e.g., decapsulation 325) using a second ciphertext (e.g., ciphertext 317) produced from an encapsulation (e.g., encapsulation 315) using the ephemeral public key. In some embodiments, the APAKE further includes producing the shared secret based on keys produced from the decapsulations using the first and second ciphertexts. In various embodiments, the APAKE further includes deriving an initial secret using an elliptic-curve key exchange (ECKE) using a generator (e.g., generator 350) selected based on the persisted public key and decrypting, using the initial secret, an ephemeral public key of the KEM received from the second device. In some embodiments, the APAKE further includes deriving the shared secret based on keys produced from the decapsulation using the persisted private key and an encapsulation using the ephemeral public key and the KEM. In various embodiments, method 650 includes establishing a secure communication channel with the second device using the established shared secret and providing data to the second device via the established secure communication channel.

### Exemplary Computer System

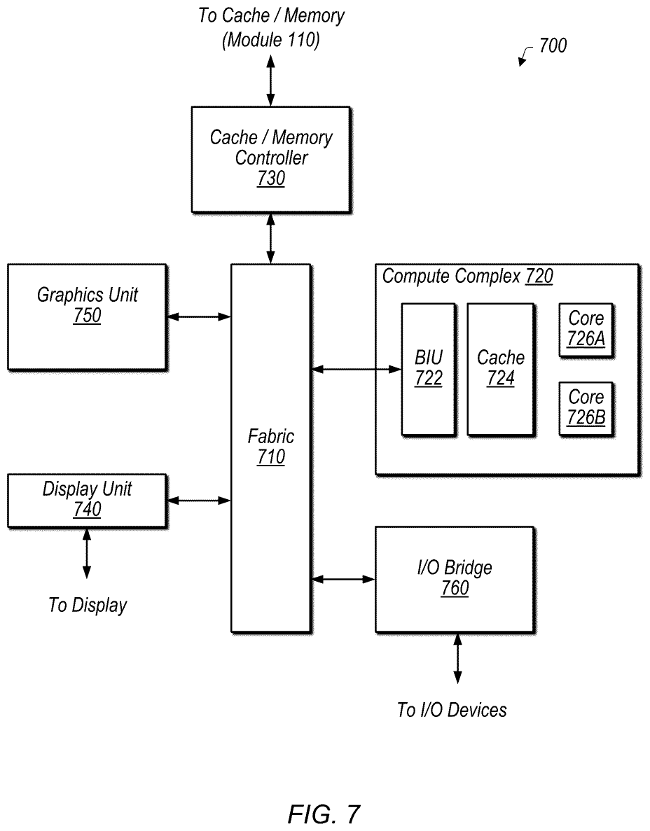

Turning now to FIG. 7, a block diagram illustrating an example embodiment of a system or device 700 is shown. In some embodiments device 700 may implement functionality one or both of device 100A and 100B. In some embodiments, elements of device 700 may be included within a system on a chip. In some embodiments, device 700 may be included in a mobile computing device, which may be battery-powered. Therefore, power consumption by device 700 may be an important design consideration. In the illustrated embodiment, device 700 includes fabric 710, compute complex 720 input/output (I/O) bridge 760, cache/memory controller 730, graphics unit 740, and display unit 750. In some embodiments, device 700 may include other components (not shown) in addition to or in place of the illustrated components, such as video processor encoders and decoders, image processing or recognition elements, computer vision elements, etc.

Fabric 710 may include various interconnects, buses, MUX's, controllers, etc., and may be configured to facilitate communication between various elements of device 700. In some embodiments, portions of fabric 710 may be configured to implement various different communication protocols. In other embodiments, fabric 710 may implement a single communication protocol and elements coupled to fabric 710 may convert from the single communication protocol to other communication protocols internally.

In the illustrated embodiment, compute complex 720 includes bus interface unit (BIU) 722, cache 724, and cores 726A-B. In various embodiments, compute complex 720 may include various numbers of processors, processor cores and caches. For example, compute complex 720 may include 1, 2, or 4 processor cores, or any other suitable number. In one embodiment, cache 724 is a set associative L2 cache. In some embodiments, cores 726A-B may include internal instruction and data caches. In some embodiments, a coherency unit (not shown) in fabric 710, cache 724, or elsewhere in device 700 may be configured to maintain coherency between various caches of device 700. BIU 722 may be configured to manage communication between compute complex 720 and other elements of device 700. Processor cores such as cores 726A-B may be configured to execute instructions of a particular instruction set architecture (ISA) which may include operating system instructions and user application instructions. These instructions may be stored in computer readable medium such as a memory coupled to memory controller 730 discussed below.

As used herein, the term “coupled to” may indicate one or more connections between elements, and a coupling may include intervening elements. For example, in FIG. 7, graphics unit 740 may be described as “coupled to” a memory through fabric 710 and cache/memory controller 730. In contrast, in the illustrated embodiment of FIG. 7, graphics unit 740 is “directly coupled” to fabric 710 because there are no intervening elements.

Cache/memory controller 730 may be configured to manage transfer of data between fabric 710 and one or more caches and memories. For example, cache/memory controller 730 may be coupled to an L3 cache, which may in turn be coupled to a system memory. In other embodiments, cache/memory controller 730 may be directly coupled to a memory. In some embodiments, cache/memory controller 730 may include one or more internal caches. Memory coupled to controller 730 may be any type of volatile memory, such as dynamic random access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR4, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit in a chip-on-chip configuration, a package-on-package configuration, or a multi-chip module configuration. Memory coupled to controller 730 may be any type of non-volatile memory such as NAND flash memory, NOR flash memory, nano RAM (NRAM), magneto-resistive RAM (MRAM), phase change RAM (PRAM), Racetrack memory, Memristor memory, etc. As noted above, this memory may store program instructions, such as a cryptographic module 110, executable by compute complex 720 to cause device 700 to perform functionality described herein.

Graphics unit 740 may include one or more processors, e.g., one or more graphics processing units (GPUs). Graphics unit 740 may receive graphics-oriented instructions, such as OPENGL®, Metal®, or DIRECT3D® instructions, for example. Graphics unit 740 may execute specialized GPU instructions or perform other operations based on the received graphics-oriented instructions. Graphics unit 740 may generally be configured to process large blocks of data in parallel and may build images in a frame buffer for output to a display, which may be included in the device or may be a separate device. Graphics unit 740 may include transform, lighting, triangle, and rendering engines in one or more graphics processing pipelines. Graphics unit 740 may output pixel information for display images. Graphics unit 740, in various embodiments, may include programmable shader circuitry which may include highly parallel execution cores configured to execute graphics programs, which may include pixel tasks, vertex tasks, and compute tasks (which may or may not be graphics-related).

Display unit 750 may be configured to read data from a frame buffer and provide a stream of pixel values for display. Display unit 750 may be configured as a display pipeline in some embodiments. Additionally, display unit 750 may be configured to blend multiple frames to produce an output frame. Further, display unit 750 may include one or more interfaces (e.g., MIPI® or embedded display port (eDP)) for coupling to a user display (e.g., a touchscreen or an external display).

I/O bridge 760 may include various elements configured to implement: universal serial bus (USB) communications, security, audio, and low-power always-on functionality, for example. I/O bridge 760 may also include interfaces such as pulse-width modulation (PWM), general-purpose input/output (GPIO), serial peripheral interface (SPI), and inter-integrated circuit (I2C), for example. Various types of peripherals and devices may be coupled to device 700 via I/O bridge 760.

In some embodiments, device 700 includes network interface circuitry (not explicitly shown), which may be connected to fabric 710 or I/O bridge 760. The network interface circuitry may be configured to communicate via various networks, which may be wired, wireless, or both. For example, the network interface circuitry may be configured to communicate via a wired local area network, a wireless local area network (e.g., via Wi-Fi®), or a wide area network (e.g., the Internet or a virtual private network). In some embodiments, the network interface circuitry is configured to communicate via one or more cellular networks that use one or more radio access technologies. In some embodiments, the network interface circuitry is configured to communicate using device-to-device communications (e.g., Bluetooth® or Wi-Fi® Direct), etc. In various embodiments, the network interface circuitry may provide device 700 with connectivity to various types of other devices and networks.

### EXAMPLE APPLICATIONS

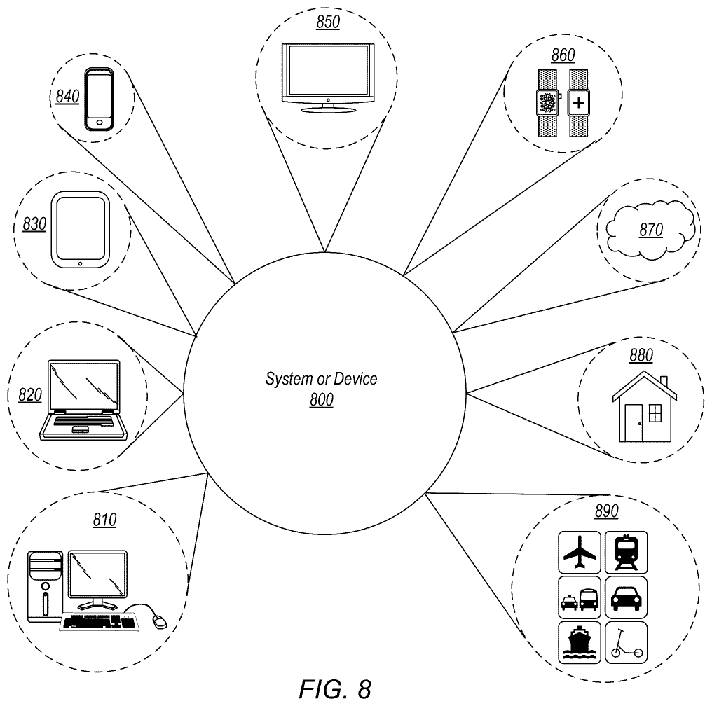

Turning now to FIG. 8, various types of systems that may include any of the circuits, devices, or system discussed above. System or device 800, which may incorporate or otherwise utilize one or more of the techniques described herein, may be utilized in a wide range of areas. For example, system or device 800 may be utilized as part of the hardware of systems such as a desktop computer 810, laptop computer 820, tablet computer 830, cellular or mobile phone 840, or television 850 (or set-top box coupled to a television).

Similarly, disclosed elements may be utilized in a wearable device 860, such as a smartwatch or a health-monitoring device. Smartwatches, in many embodiments, may implement a variety of different functions—for example, access to email, cellular service, calendar, health monitoring, etc. A wearable device may also be designed solely to perform health-monitoring functions, such as monitoring a user's vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 800 may also be used in various other contexts. For example, system or device 800 may be utilized in the context of a server computer system, such as a dedicated server or on shared hardware that implements a cloud-based service 870. Still further, system or device 800 may be implemented in a wide range of specialized everyday devices, including devices 880 commonly found in the home such as refrigerators, thermostats, security cameras, etc. The interconnection of such devices is often referred to as the “Internet of Things” (IoT). Elements may also be implemented in various modes of transportation. For example, system or device 800 could be employed in the control systems, guidance systems, entertainment systems, etc. of various types of vehicles 890.

The applications illustrated in FIG. 8 are merely exemplary and are not intended to limit the potential future applications of disclosed systems or devices. Other example applications include, without limitation: portable gaming devices, music players, data storage devices, unmanned aerial vehicles, etc.

The present disclosure includes references to “an embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . W, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

What is claimed is:

1. A method, comprising:
establishing, by a first device, a shared secret for secure communication between a first device and a second device using a hybrid password-authenticated key exchange (PAKE), wherein the hybrid PAKE includes:
deriving an initial secret using an elliptic-curve key exchange (ECKE) using a generator selected based on a password;
encrypting, using the initial secret, a public key of a key encapsulation mechanism (KEM) for transmission to the second device;
decrypting, using the initial secret, a ciphertext received from the second device encapsulating the shared secret using the public key; and
decapsulating the shared secret from the decrypted ciphertext using a private key of the KEM;
establishing, by the first device, a secure communication channel with the second device using the established shared secret; and
providing, by the first device, data to the second device via the established secure communication channel.

2. The method of claim 1, wherein the encrypting uses the initial secret and the password.

3. The method of claim 2, wherein the encrypting includes:
a first encryption of the public key using the password; and
a second encryption of the public key using the initial secret.

4. The method of claim 2, wherein the encrypting includes:
hashing the initial secret and the password to produce a hashed key; and
encrypting, via one-time-pad (OTP), the public key using the hashed key.

5. The method of claim 1, wherein the hybrid PAKE further includes:
hashing the decapsulated shared secret with the password to establish the shared secret.

6. The method of claim 1, wherein the KEM is based on a learning with errors (LWE) algorithm.

7. The method of claim 6, wherein the KEM is Module-Lattice-Based KEM (ML-KEM).

8. A non-transitory computer readable medium having program instructions stored therein that are executable by a first device to perform operations comprising:
establishing a shared secret for secure communication between the first device and a second device using a hybrid password-authenticated key exchange (PAKE), wherein the hybrid PAKE includes:
deriving an initial secret using an elliptic-curve key exchange (ECKE) using a generator selected based on a password;
encrypting, using the initial secret, a public key of a key encapsulation mechanism (KEM) for transmission to the second device;
decrypting, using the initial secret, a ciphertext received from the second device encapsulating the shared secret using the public key; and
decapsulating the shared secret from the decrypted ciphertext using a private key of the KEM;
establishing a secure communication channel with the second device using the established shared secret; and
providing data to the second device via the established secure communication channel.

9. The computer readable medium of claim 8, wherein the encrypting uses the initial secret and the password.

10. The computer readable medium of claim 9, wherein the encrypting includes:
a first encryption of the public key using the password; and
a second encryption of the public key using the initial secret.

11. The computer readable medium of claim 9, wherein the encrypting includes:
hashing the initial secret and the password to produce a hashed key; and
encrypting, via one-time-pad (OTP), the public key using the hashed key.

12. The computer readable medium of claim 8, wherein the encrypting includes:
hashing the initial secret and the password to produce a hashed key; and
encrypting, via one-time-pad (OTP), the public key using the hashed key.

13. The computer readable medium of claim 8, wherein the KEM is based on a learning with errors (LWE) algorithm.

14. The computer readable medium of claim 13, wherein the KEM is Module-Lattice-Based KEM (ML-KEM).

15. A first device, comprising:
one or more processors; and
memory having program instructions stored therein that are executable by the one or more processors to cause the device to perform operations including:
establishing a shared secret for secure communication between the first device and a second device using a hybrid password-authenticated key exchange (PAKE), wherein the hybrid PAKE includes:
deriving an initial secret using an elliptic-curve key exchange (ECKE) using a generator selected based on a password;
encrypting, using the initial secret, a public key of a key encapsulation mechanism (KEM) for transmission to the second device;
decrypting, using the initial secret, a ciphertext received from the second device encapsulating the shared secret using the public key; and
decapsulating the shared secret from the decrypted ciphertext using a private key of the KEM;
establishing a secure communication channel with the second device using the established shared secret; and
providing data to the second device via the established secure communication channel.

16. The first device of claim 15, wherein the encrypting uses the initial secret and the password.

17. The first device of claim 16, wherein the encrypting includes:
a first encryption of the public key using the password; and
a second encryption of the public key using the initial secret.

18. The first device of claim 16 wherein the encrypting includes:
hashing the initial secret and the password to produce a hashed key; and
encrypting, via one-time-pad (OTP), the public key using the hashed key.

19. The first device of claim 15, wherein the encrypting includes:
hashing the initial secret and the password to produce a hashed key; and
encrypting, via one-time-pad (OTP), the public key using the hashed key.

20. The first device of claim 15, wherein the KEM is Module-Lattice-Based KEM (ML-KEM).
